(19) United States
(12) Patent Application Publication
(10) Pub. No.: US 2007/0088736 A1
(43) Pub. Date: Apr. 19, 2007

(54) Record authentication and approval transcript

(75) Inventor: Tod DeBie, Costa Mesa, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(73) Assignee: FileNet Corporation

(21) Appl. No.: 11/255,534

(22) Filed: Oct. 19, 2005

(51) Int. Cl. G06F 7/00

(52) U.S. Cl. 707/102

(57) ABSTRACT

Authenticating a declared or approved record and creating a transcript related to the declaration or approval. The transcript is created based on available information at the time of declaration. The collected available information may include the user/program declaring the record, the method used to declare and/or approve the record and record content, any log or audit entries generated during the declaration, the document and record metadata (including globally unique identifiers for the record and content objects), and/or a hash of the record. The collected information may also include user information, e.g., the user's IP address or MAC address. The transcript may be saved, and linked to the record. Additionally, the hash may be revalidated at various times to ensure the accuracy of the record. Moreover, related logs may be archived and declared as records.

### CROSS-REFERENCE TO RELATED APPLICATIONS

This application is related to previously-filed U.S. patent application entitled “Automated Records Management Based on Business Process Management” filed on or about Oct. 15, 2004, with inventors Bao Vu and Lauren Mayes, assigned to the assignee of the present application.

### BACKGROUND

1. Field

The present disclosure relates generally to records management and, more particularly, to authentication of declared and/or approved records.

2. Description of Related Art

Authentication of business records and approvals related to such records have become increasingly essential to the future and success of a business. For example, because a new age of corporate governance has emerged, the need to prove records as authentic has become more widespread. A corporation may be required to show that it has complied with preset processes or policies, and that records related to these processes are authentic and were not cooked up after the fact.

Many present policies related to corporate compliance have been embodied in legislation. The Sarbanes-Oxley Act and the Health Insurance Portability and Accountability Act of 1996 are examples of such legislation. Due to regulations such as these, it may be deemed necessary for a corporation to manage and maintain its records in a particular manner. Accordingly, a significant number of companies now maintain formal records management programs, and it is widely agreed that such programs are important to the success of a business.

However, current records management programs may not address the needs of today's businesses. For example, they do not include ways to prove that the records are not changing. Moreover, they may not include ways to identify the user that created the record. Even if they could identify the user that created the record, they may not include fraud protections, e.g., identifying the computer from which the user created the record.

Current records management programs may also lack protections that promote the consistent application and enforcement of records management policies. For example, some information technology systems may not be structured to support desired records management policies.

Moreover, process information required for audit and compliance is often not recorded. For example, it may be desirable for certain records to be created or declared by authorized persons.

While records management programs have been developed to address these issues, many such programs have failed because, among other things, they are perceived as burdensome and time-consuming to the user. For example, a user may be required to sign documents showing they declared a record. Moreover, the user may be required to show they have the proper authorization to view a record that has been subject to an authentication process.

There is a need for a records management system that is less burdensome and time-consuming to the user, and that provides proof that a record is authentic.

There is even further a need for a records management program that promotes the consistent application and enforcement of records management policies.

There is still further a need for a system that gives users greater confidence in moving from paper processes to electronic processes that they are following preset policies and procedures.

### BRIEF SUMMARY

The present disclosure addresses the needs noted above by providing a system and method for authenticating a declared and/or approved record. In accordance with one embodiment of the present disclosure, a method is provided for authenticating a declared and/or approved record for a records management system.

The method comprises receiving declaration or approval of an object as a record. The method further includes collecting available information related to the declaration or approval, including information from the computer of the user that declares or approves the record. The method also includes creating a transcript of the information related to the declaration or approval, saving the transcript, and linking the transcript to the record.

In another embodiment of the present disclosure, computer-readable media is provided containing programming for authenticating a declared and/or approved record in a records management system. When executed on a computer, the programming causes a processor to receive declaration or approval of an object as a record. The programming further causes the processor to collect available information related to the declaration or approval, including information from the computer of the user that declares or approves the record, and create a transcript of the information related to the declaration or approval. The programming also causes the processor to save the transcript, and link the transcript to a record.

In yet another embodiment of the present disclosure, a system is provided for authenticating a declared and/or approved record in a records management system. The system comprises a processor, and memory coupled to the processor. The processor is configured to receive declaration or approval of an object as a record, and collect available information related to the declaration or approval, including information from the computer of the user that declares or approves the record. The system is further configured to create a transcript of the information related to the declaration or approval. The system is configured to save the transcript in the memory, and link the transcript to the record.

These, as well as other objects, features and benefits will now become clear from a review of the following detailed description of illustrative embodiments and the accompanying drawings.

### BRIEF DESCRIPTION OF DRAWINGS

FIG. 1 is a flowchart illustration of a method for authenticating a declared and/or approved record in accordance with one embodiment of the present disclosure.

FIG. 2 is a chain of custody flowchart showing the path of an electronic record used as evidence.

FIG. 3 is an illustration of a transcript that may be created in accordance with one embodiment of the present disclosure.

FIG. 4 is a block diagram representation of a single architecture that may be used for authenticating a declared and/or approved record and creating an approval transcript in accordance with one embodiment of the present disclosure.

### DETAILED DESCRIPTION OF ILLUSTRATIVE EMBODIMENTS

The present disclosure provides a system, computer program and method for authenticating a record, including by creating and saving a transcript related to a declared record. For purposes of creating the transcript, the system collects available information related to the declaration or approval of an object as a record. The transcript, which includes available information related to the declaration or approval of an object as a record, may be saved and linked to the record content. In addition, the saved transcript may optionally be declared a record and linked as a related record to the primary record. The record content may be managed by a records management system.

Various options may also be available in connection with record authentication, e.g., exporting the authentication transcript along with the primary records being exported, revalidating record hash values to enable greater confidence that there are no problems with transmission or saving of an authenticated record, as well as archiving and declaring logs as records.

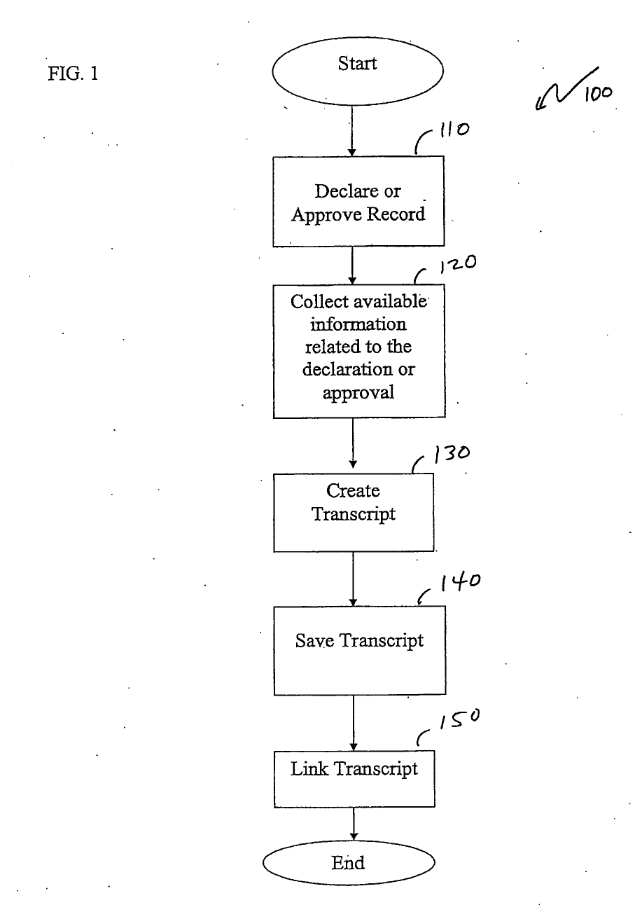

Referring now to FIG. 1, illustrated is a method for authenticating a record and generating an approval transcript 100 in accordance with one embodiment of the present disclosure. First, the system receives declaration of an object as a record at step 110. In some cases, the record may also need to be approved, e.g., by an authorized person prior to being considered a record. In this case, the system might wait for an approval (from an authorized end user and/or records manager) before treating an object as a record.

The object that is declared or approved as a record may take various forms. For example, the object may be an electronic document including an e-mail, or a physical record or artifact. A record can be any object that an organization desires to maintain and manage in a reliable manner.

An electronic record may be information recorded in a form that requires a computer or other machine to process the information. Electronic records may include anything from e-mail messages to documents saved in a word processing application to audio recordings. Physical records may be information recorded in physical form, such as a file containing paper records, videotapes, audiotapes, etc. Records may be created based on physical artifacts, e.g., items in a police evidence room.

A record may be declared in numerous ways. For example, a user may consciously decide to declare a document as a record by following his or her corporate protocol in declaring the record. In some instances, the user may not be aware that he or she is declaring a record. The record declaration process may occur automatically based on actions the user takes. The user's records management system may be set up so that, when certain user actions are taken, a record is automatically declared.

Record declaration may occur when a potential record is added to the system. In the case of electronic content, declaration may occur when a document is created or published, or upon the creation of a new document version, or when an e-mail is transmitted. For electronic documents as well as other types of records, the records may be automatically declared.

A record may be declared automatically in other ways. For example, records may be declared automatically via e-mail filters. These filters may result from e-mail programs that permit the creation of filters. These filters may provide that when an e-mail meets certain criteria, it is to be declared a record. Also by way of example, a look-up function may be used to declare e-mails received from certain identified persons or companies as records. When an e-mail is received from a specified user and/or company, the look-up system may identify the user or company as a party whose e-mails should be declared as records.

Records may also be generated in a variety of other uses and applications, e.g., part of a transaction, or during the course of a process.

For example, establishing and maintaining proper chain of custody is an important evidentiary aspect in a criminal investigation. In order to show that a record is authentic and as obtained by the police department, certain procedures must be followed. A record in a criminal investigation may pass through a number of hands during the investigation process.

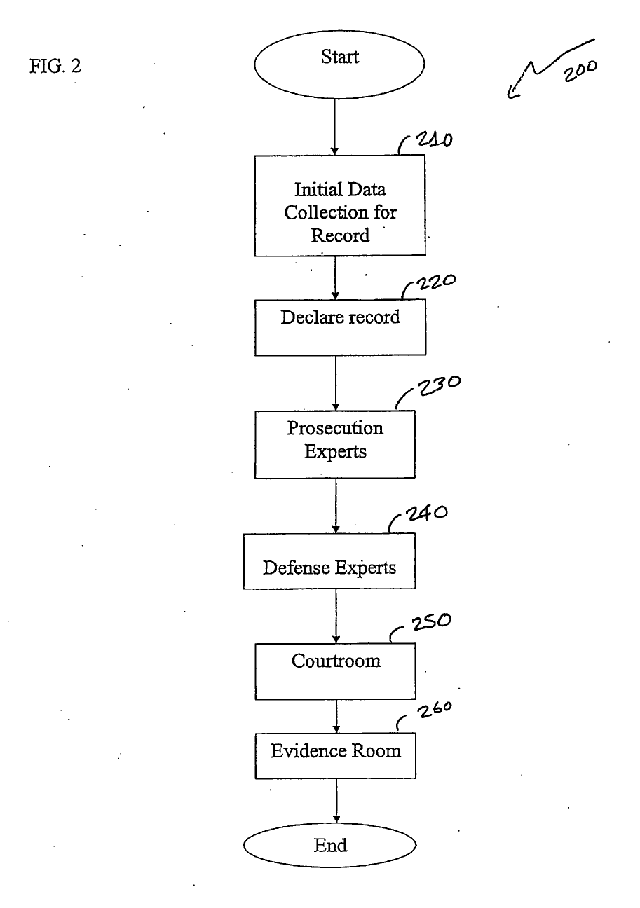

Referring now to FIG. 2, illustrated is a chain of custody flowchart 200 showing the path of an electronic record captured on a physical medium and used as evidence. In this example, the electronic record is captured on a CD-ROM used as evidence against a criminal defendant. A records management system may manage a CD-ROM and its contents as a physical record, if the CD-ROM is external to, and separate from, the records management system. Alternatively, if a CD-ROM is used as a primary or secondary storage medium within the records management system, the electronic contents of the CD-ROM may be managed directly by the system as an electronic record within the system. In the example in FIG. 2, the CD-ROM is separate from the records management system and is managed as a physical record. The flowchart 200 shows the path of the CD-ROM from the time the CD-ROM is collected as evidence up through the time of trial where the CD-ROM is released to the courtroom.

At step 210, the initial data collection is processed for the CD-ROM. Data collected during this process may include the name of the police officer or investigator who received the CD-ROM. The initial data collected may also include the date, time and place of receipt of the CD-ROM as evidence. The initial data collection may further include other particulars related to the CD-ROM, e.g., the size of content on the CD-ROM. The initial data collected may also include writings on labels related to the CD-ROM, etc.

At step 220, the CD-ROM may be declared as a record in police custody. In this case, the records custodian or other person declaring the CD-ROM as a record may consciously copy the electronic contents of the CD-ROM into a file on the records management system and declare the file as a separate electronic record.

After the CD-ROM has been declared as a record, and during the course of the criminal investigation, the CD-ROM may pass through the hands of various experts for testing. As set forth in greater detail hereinbelow, a transcript may be generated of various comments that are related to the CD-ROM. Such entries may include the location where the CD-ROM was moved. The system may also automatically show when the CD-ROM was checked out and by whom. For example, at step 230, the CD-ROM may pass through the hands of one or more prosecution experts for testing. The prosecution expert(s) may check out the record through a records management system in which they have been authorized to perform certain actions, and where they have been assigned certain user identifications.

The CD-ROM may also be viewed and/or analyzed by one or more defense experts at step 240. At step 250, the CD-ROM may be released to a courtroom for trial. At step 260, the CD-ROM may be checked back into the evidence room for preservation.

It should also be understood that a separate set of records could be declared for various discrete steps. For example, as in the example above, a set of records could be declared for the CD-ROM that originally contained a computer file. A separate set of records could also be maintained for a copy of the electronic contents of the CD-ROM.

A system incorporating the features of the present invention may be configured such that an authorized user may declare records by adding documents. The declaration or approval may be made from a productivity tools suite such as MICROSOFT OFFICE™, an email program such as MICROSOFT OUTLOOK™, and events that automatically declare the record.

Upon declaration or approval, the system may be designed so that the record cannot be deleted, even by the creator of the record.

Referring back to FIG. 1, once the record has been declared or approved, the system collects available information related to the declaration or approved at step 120. Software having executable program instructions may be used to collect available information. Hardware may operate in conjunction with the software in order to collect available information related to the declaration or approval. The collected available information may include the user declaring the record (i.e., the declarant) and the program used to declare the record. In the criminal evidence example, the record may be created by a records clerk, investigator or other authorized person.

Information may be collected on the authorized user when the user declares and/or approves a record. For example, the user's IP address, from which the declaration is made, may be recorded. Moreover, the address of a user's hardware device that has been employed to gain access to the network (or “MAC address”) may be collected and made a part of the transcript related to the declared or approved record.

The system may further collect information related to the method used to declare and/or approve the record and its content. The record may have been declared manually by, for example, a records clerk, as in the criminal evidence example set forth above.

The method of declaration and/or approval that is collected by the system may also include an e-mail method, e.g., where a record is declared via e-mail. The method may also be an event-based declaration. Event-based content management systems allow actions to be associated with events that occur within the system. For example, a user saving a document into a certain folder of the system is an event that could be associated with the action of declaring that document a record to be managed by a records management component of the system. In this way, declaration of records may be accomplished automatically based on events occurring within a system.

Record declaration may also be triggered through a bulk import process. Data may be migrated in a bulk import process, and the data may be declared as a record. In a multiple import process, documents may be scanned in via fax or other image recognition system and automatically declared as records.

The system may also collect log or audit entries generated during the declaration. For example, if the record was declared using the multiple import process, the log or audit entries will indicate same.

The system may collect information such as the document and record metadata (including globally unique identifiers of the record and content objects). Globally unique identifiers are algorithmically built to give a record a unique code, and are commonly used with records management systems.

Collected information may include a hash of the record. The hash may be determined by running an algorithm across all content of the data. It then gives a sum number that may represent a unique fingerprint for that data. The odds can be made extremely low that one would end up with the same hash for any two documents.

Collected information may include information for the declarant, e.g., the declarant's IP address. The declarant's IP address may be the logical address used by the TCP/IP protocol. Other declarant information may include the hardware address (or MAC address) of the declarant's device that is connected to the network.

Other information that may be collected includes, but is not limited to, time stamps for content and record lifecycle events such as document creation, approval and record declaration. Moreover, the collected information may include, but is not limited to, the identity and version of a business process used to automate any of the processes involved in document creation, approval and record declaration. In essence, the collected information can be any information that the user desires to know and that is capable of being retrieved. Based on the information that is collected, a transcript is created at step 130. The transcript may be saved at step 140. The transcript may be viewed using a number of software applications, including WORKPLACE™ and RECORDS MANAGER™ records management software, both of which are commercially available from the present assignee, FileNet Corporation. When viewing the transcript in the WorkPlace or Records Manager software applications, the transcript may be transformed into a human readable page. In order to verify the contents of the record and to ensure the content has not changed, the hash of the content may be revalidated and compared to the stored value.

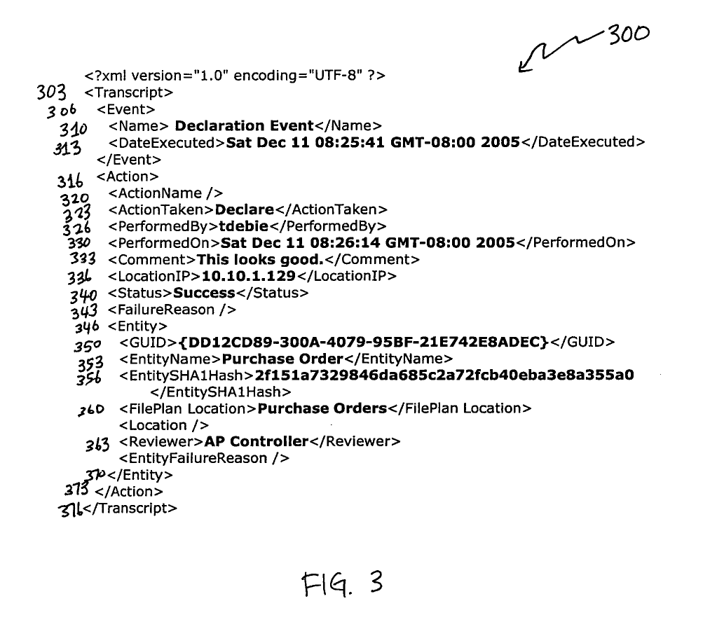

Referring now to FIG. 3, illustrated is a transcript that may be created in accordance with one embodiment of the present disclosure. This declaration transcript 300 is provided in extensible markup language (.xml) format. The transcript may also be recorded in other formats such as HTML, PDF or MICROSOFT™ WORD™, or each element of the transcript may be stored in a database as separate or combined elements or in a log file. The transcript 300 includes available information related to a declaration or approval of an object as a record. Available information may include the method used to declare and/or approve the record, information regarding the declaration action taken, and various information regarding the identification and location of the record that has been declared or approved.

The declaration transcript 300 reveals, in .xml language format, that it is a “transcript” as indicated at line 303. The transcript also shows that the subject of this transcript is a declaration event as shown at lines 306 and 310. In this example, the transcript could have been created using a manual declaration method, e.g., through a declaration wizard. The transcript could have also been created when a declaration was triggered by the user's actions. For example, where a user approves a purchase order in a workflow an event-based declaration may be triggered. When the user approves a purchase order via e-mail, an e-mail declaration may be triggered. The transcript for a workflow-based declaration could include the identity and version of the workflow script that executed the declaration action.

The transcript 300 may also include log or audit entries, e.g., the date and time an event was executed. The date and time of execution is shown at line 313. This date and time may represent the date and time that the record's declarant started the declaration process at his/her computer, e.g., by opening a declaration wizard on a desktop. In the present illustration, the event was executed at 8:26:14 GMT—8:00 on Dec. 11, 2005, as indicated at line 313. At lines 316, 320 and 323 information regarding the action related to the transcript is shown. In the present illustration, the action taken is to “declare” a record as shown at line 323. The transcript includes the user identification for the user performing the action at line 326. In this illustration, user “tdebie” has performed a declaration action.

At line 330, the transcript 300 shows another log or audit entry. In this case, it is the date and time the declaration action was performed. The “performed on” date and time at line 330 differs from the date and time at line 313 in that the “performed on” date and time indicates the time the action was completed. In this case, the declaration action was completed on Dec. 11, 2005 at 08:26:14 GMT—8:00.

At line 333, the user may input comments related to the action. Here, the user has input “This looks good.” At line 336, the transcript further includes the user's IP address from which the declaration is made. Here, the address is “10.10.1.129”.

The status of the action is indicated at line 340. Here, the status is “Success”, meaning the action was successful. If the action had failed, this could have been noted at line 340. If the action had failed, then at line 343, a reason for failure of the action could be noted. The status could also be noted as other than success or failure. For example, the status could be shown as “in progress” where the user has started, but has not yet performed, the declaration action. Starting at line 346, information regarding the record or “entity” is indicated. For example, record metadata may be shown as part of the information regarding the record or entity. A globally unique identifier (GUID), such as that shown at line 350, could be made a part of the transcript's illustration of metadata. The GUID is an industry standard, and may be randomly or arbitrarily assigned to uniquely identify a particular record.

At line 353 of transcript 300, the declared record type is shown. Here, the title is “purchase order”. At line 356, the hash value of the record is shown. The hash may be based on, or performed by, an algorithm used to identify a record based on the record's content. Such algorithms are known in the art. The hash value uniquely identifies the record based on the record's content. The hash may be used to confirm that all of the original record's content is available where, for example, the file has been copied or transmitted from one location to another.

At line 360, the file plan location for the declared and/or approved record is shown. Treatment of these records is generally based on a file plan. The file plan may require, for example, that the record be destroyed after a specified period of time. In the present illustration, the record is treated according to rules of the file plan for purchase orders.

At line 363, a reviewer is designated for the record. In the present illustration, the reviewer is “AP Controller” or accounts payable controller. This controller will review actions associated with this record, and may have the authority to control actions related to the record. For example, the controller may place a hold on the record to make sure that it is not destroyed as set forth in the file plan for purchase orders.

At line 366, an entity failure reason may be illustrated. For example, if the record was not approved by the reviewer, the entity failure reason may indicate same. Moreover, if a file plan location could not be found or assigned to a particular record, the entity failure reason may indicate that a file plan location could not be found or assigned. The entity failure reason may relate to any reason a record could not be placed or identified properly in the system, even if the declaration action has been undertaken properly. At line 370, information relating to the entity ends. At line 373, information related to the action ends. At line 376, the .xml transcript is closed.

Referring back to FIG. 1, at step 150, the transcript may be linked to the primary record information object (RIO) as well as the primary record content. The RIO may be a pointer with information regarding the location of the record. As an option, the transcript itself may be declared as a record, in addition to the primary record that is the subject of the transcript. Alternatively, the transcript may be left standalone with no connection to the primary record.

After the primary record has been declared and the transcript saved, if the transcript has been declared as a record or linked to the primary record, the transcript may be conveniently treated in the same manner as the primary record. For example, many records are subject to disposition schedules which determine a time for the record's disposition, whether via export, transfer, interim transfer, or destruction. The authentication transcript may also be disposed of in the same manner as the primary record. For example, when the primary record is exported, so is the transcript.

A disposition schedule may be assigned to a category or folder in the file plan. Where disposition schedules have already been configured, they may be added while adding a new container. If the hierarchy is also constructed, the disposition schedule may be added to the appropriate level after hierarchy construction. A disposition schedule may be automatically inherited by lower level entities. A disposition may also be designed to be overridden.

A disposition schedule may be associated with a record category or folder or other element of a file plan. The disposition schedule may include several elements. For example, a disposition schedule may include an event trigger that triggers cutoff. Cutoff may be the beginning of the retention period which signals the end of active use. Upon a cutoff action, a workflow may be automatically launched for approval of the cutoff. An event offset may optionally be provided as part of a disposition schedule, and may delay time between an event trigger and a cutoff. Disposition phases may be defined to control the retention of records, and each phase of disposition may have an action associated with a workflow.

Cutoffs and vital record reviews are described in greater detail in co-pending U.S. patent application entitled “Automated Records Management Based on Business Process Management” filed on or about Oct. 15, 2004, with inventors Bao Vu and Lauren Mayes, assigned to the assignee of the present application.

The event triggers used in a file plan may be internal events, such as those related to the property of a particular category, folder, volume or record. The event trigger may also be an external event that represents an action that occurs outside the system. For example, in a doctor's office, a patient may decide to terminate his relationship and see another doctor. Such a decision may trigger a cutoff so that the patient records begin their disposition phase. A recurring event may include a start date and frequency. A recurring event may be a date for review of vital records. The event may also be a predefined date. For example, all records for a certain calendar year may be cutoff at the end of a particular year.

Disposition phases may be defined within the file plan such that they include actions. Each action may have a type and an associated workflow that is launched to carry out the action. In this manner, workflows may be configured for use in a disposition schedule. Workflows may also be duplicated and modified to implement multiple actions of the same type. For example, if a business commonly transfers records on an interim basis to a particular locale, the disposition schedule may include actions related to that transfer. Disposition phase action types may include review actions, export actions, interim transfer actions, transfer actions and destroy actions. A review action may indicate that a record should be reviewed to determine if its disposition should be changed. An export action may be used to copy records to an external system without removing them. A transfer action may be used to export records to an external system so that they may be removed afterwards. A destroy action may be used to remove records so they cannot be recovered. There may be an option used to retain metadata.

A disposition schedule may be pre-configured to trigger events and phase actions. In adding a new disposition schedule, a user may be required to provide a name for a schedule, select a trigger for the schedule, define a disposition event offset, select cutoff action (option) and set disposition phases. One or more disposition phases may be added to a disposition schedule in a file plan. Phases should be in logical order. For example, a disposition schedule should be defined so that nothing follows a destruction or transfer phase. A retention period should be included for each phase. For example, a record may be reviewed one year after its cutoff, and destroyed five years after its cutoff.

Record aggregation may define the file plan level that a schedule impacts. For example, it may define which record is cutoff and then is impacted by a disposition phase.

A disposition schedule may be inherited by folders in a category or the folders may have their own disposition schedules, whether according to record types or otherwise.

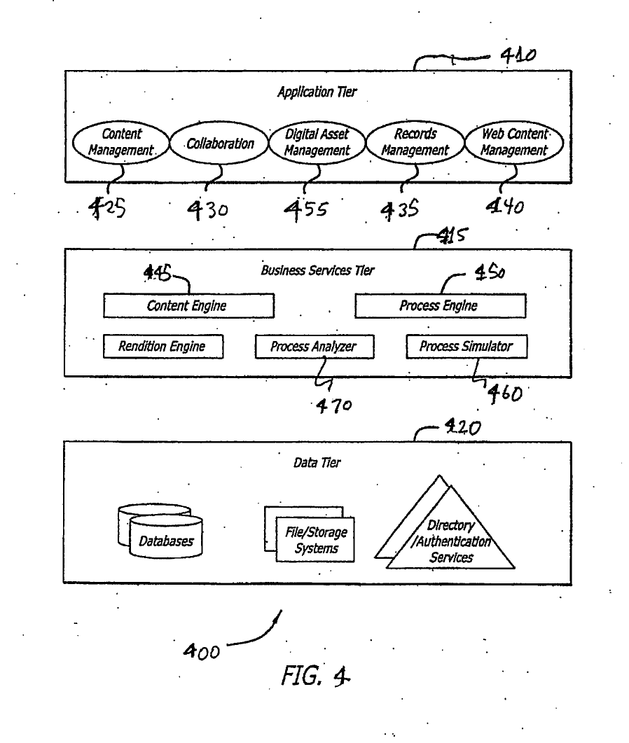

The present disclosure provides for integration of records authentication and approval transcripts with records management using a single platform. Referring now to FIG. 4, illustrated is a block diagram representation of a single architecture 400 that includes an application tier 410, a business services tier 415, and a data tier 420. A single architecture may be provided thereby for collaboration 430, records management 435, web content management 440, digital asset management 455 and content management 425 at the application tier, while a content engine 445 and a process engine 450 are used to manage the processes and content for all the separate systems that perform collaboration 430, records management 435, web content management 440, content management 425 and digital asset management 455. The content engine 445 and process engine 450 may be controlled by separate stand-alone servers. Alternatively, the content engine 445 and process engine 450 may be controlled by a single server, thereby resulting in a unified content and process engine.

Using this architecture, business process management may be performed such that the collaboration system 430 may be configured to initiate—automatically or otherwise—one or more processes in the process engine system 450, and vice versa. These processes may be record authentication tasks, including transcript generation.

A process simulator 460 may be used to model business processes and simulate them under real-world conditions. By taking existing processes and simulating various scenarios based on relevant data, a business may discover how to remove bottlenecks, better align resources and reduce overall costs.

A process analyzer 470 may be used to deliver dynamic reports with historical and real-time data that enable a business to monitor and analyze processes, optimize operations and proactively address business trends. The process analyzer 470 may be based on on-line analytical processing (OLAP) technology, and it may track the performance of key business processes. The process analyzer 470 may also be used in connection with the collaborative environment.

Using the above-described architecture 400, content may also be published or declared as a record. In this manner, the records may be managed within the system, and content may be managed both inside and outside the system. For example, after a record is declared, the system may automatically classify one or more of the transcripts or store information associated with one or more of these records in the records management system.

One or more of the various management applications of the application tier 410 may be a part of separate, stand-alone systems that have been brought together and integrated merely for the purpose of creating the record authentication system with records management.

Using this single architecture, logs may be taken from all systems, including the content engine, process engine, and/or the application tier. These logs may be added to the content engine, and declared as records.

In implementing records authentication processes and generating an approval transcript, a computer processing system may operate in conjunction with a memory system, and user interfaces to design and implement the features of the record authentication as well as generation, linking to, and saving an approval transcript.

The computer processing system may be configured to perform any or all portions of the functions described in this application, as well as other functions. For example, the computer processing system may be configured to manage the various components in the system, including the various objects, processes and linking relationships that are discussed herein. The computer processing system may be configured to create, delete and modify any or all of these components.

The computer processing system may be constructed from any type of computer processing system and may include computer hardware and/or software. The computer processing system may include a general purpose computer or a computer that is dedicated to the specific functions of the system. The computer processing system may include a single computer or multiple computers and/or processors. When using multiple computers and/or processors, the multiple computers and/or processors may be at a single location or at several locations. When using multiple computers and/or processors, the multiple computers and/or processors may be interconnected by a network system, such as a local area network, a wide area network, and/or the Internet. The computer processing system may include any combination of these embodiments.

The memory system may include any type of memory system, including one or more hard disk drives, magnetic tape drives and/or RAMs. The memory system may consist of a single device or multiple devices. When multiple devices are used, they may all be at the same location or at different locations. When multiple devices are used, appropriate hardware and/or software may be used to facilitate their intercommunication.

Any one of the functions that are performed by the computer processing system may be performed in response to input from the user interface that originates with one or more users of the record authentication and approval transcript system. The user interface may include any type of user interface components, including one or more keyboards, mice and/or display screens. The user interface may include appropriate software to process information. The user interface may include communication links to other computing systems and/or databases.

The memory system may contain a plurality of record objects, data objects and other software objects. The memory may be configured to receive declaration or approval of an object as a record. Processes related to the enterprise other than record authentication and approval may also be stored in the memory system.

The memory system may include a plurality of relationships or links to approval transcripts. Each link may specify an association between two or more components in the record authentication and approval transcript system, such as between a record object and a linked approval transcript.

The computer processing system may be configured to allow the user operating through the user interface to create, modify and/or delete one or more of the record objects and linked approval transcripts and/or links/relationships therebetween.

The memory system may include a version history which is created and managed by a version control system in the computer processing system. As changes are made to one or more of the components in the record authentication system, such as to one or more of the record objects, the version control system may retain information in the version history that will allow each component to be reconstructed to each of its states prior to each of the changes that are made to it. The information that is stored in the version history may include complete replicates of earlier component versions and/or merely information indicative of the changes that are made thereto.

The processing system may be used to implement a record authentication system. The record authentication system may be configured to cause one or more records to be authenticated and generate an approval transcript.

A security system may be employed in the computer processing system to govern who may access record objects and approval transcripts that may be related to them. The security may be applied at various levels, including to groups of users and/or particular classes of information.

An audit system may be included in the computer processing system to keep an audit of accesses that are made, including accesses to the record objects and/or the record authentication system. The audit system may keep track of who accesses a record object, when it is modified, who authorizes the modification, who generates documentation related to the record objects and approval transcripts, and when these events take place. All of this information may be reported on for auditing and compliance reporting purposes.

A navigation system may be included in the computer processing system to allow a user of the system to navigate from one component of the system, such as from a record object and/or other data object, and/or to approval transcripts that are related to the record object. The navigation system may include functionality that allows all links to a particular component, such as to a record object or approval transcript, to be displayed, and to allow the user to select from this display the next component with which the user wishes to work.

External management systems may be linked to the record authentication system.

The record authentication system may include a rules-based regulatory reporting system. Regulatory reporting controls may be used to monitor record authentication status and plan scheduled activities. Exception reporting may be controlled automatically by the system, once certain pre-defined criteria are not met. Business rules may be combined with automated processes to support automatic notifications and reminders.

Trends and forecasts may be reported. Using a process analyzer and simulation tools, trends and patterns in business process management usage may be identified and explored with what-if scenarios.

While the specification describes particular embodiments of the present invention, those of ordinary skill can devise variations of the present invention without departing from the inventive concept.

We claim:

1. A method for authenticating a declared and/or approved record for a records management system, the method comprising the steps of:
receiving declaration or approval of an object as a record;
collecting available information related to the declaration or approval, including information from the computer of the user that declares or approves the record;
creating a transcript of the information related to the declaration or approval;
saving the transcript; and
linking the transcript to the record.

2. The method of claim 1, further comprising:
declaring the saved transcript as a record according to the same file plan as the primary record.

3. The method of claim 1, wherein information related to the declaration or approval includes the user or program declaring or approving the record.

4. The method of claim 1, wherein information related to the declaration or approval includes the internet protocol address from which the user declares or approves the record, or the media access control address that identifies the node from which the user declares or approves the record.

5. The method of claim 1, wherein information related to the declaration or approval includes a name or other description of a method used to declare or approve the record.

6. The method of claim 1, wherein information related to the declaration or approval includes at least one log or audit entry that was generated during the declaration or approval.

7. The method of claim 6, further comprising:
archiving the at least one log; and
declaring the at least one log as a record.

8. The method of claim 1, wherein information related to the declaration or approval includes a globally unique identification number for the record.

9. The method of claim 1, wherein information related to the declaration or approval includes a hash of the record.

10. The method of claim 9 further comprising:
revalidating the hash of the content; and
comparing the revalidated hash to a stored hash value.

11. The method of claim 1, further comprising:
transforming the transcript into a human-readable format.

12. The method of claim 1, wherein the transcript is disposed of according to the same disposition schedule as the primary record.

13. Computer-readable media containing programming for authenticating a declared and/or approved record in a records management system that, when executed on a computer, causes a processor to perform the steps of:
receiving declaration or approval of an object as a record;
collecting available information related to the declaration or approval, including information from the declarant's computer;
creating a transcript of the information related to the declaration or approval;
saving the transcript; and
linking the transcript to the record.

14. The computer program of claim 13, further comprising:
declaring the saved transcript as a record according to the same file plan as the primary record.

15. The computer program of claim 13, wherein information related to the declaration or approval includes the user or program declaring or approving the record.

16. The computer program of claim 13, wherein information related to the declaration or approval includes the internet protocol address from which the user declares or approves the record, or the media access control address that identifies the node from which the user declares or approves the record.

17. The computer program of claim 13, wherein information related to the declaration or approval includes a name or other description of a method used to declare or approve the record.

18. The computer program of claim 13, wherein information related to the declaration or approval includes at least one log or audit entry that was generated during the declaration or approval.

19. The computer program of claim 18, further comprising:
archiving the at least one log; and
declaring the at least one log as a record.

20. The computer program of claim 13, wherein information related to the declaration or approval includes a globally unique identification number for the record.

21. The computer program of claim 13, wherein information related to the declaration or approval includes a hash of the record.

22. The computer program of claim 21, further comprising:
revalidating the hash of the content; and
comparing the revalidated hash to a stored hash value.

23. The computer program of claim 13, further comprising:
transforming the transcript into a human-readable format.

24. The computer program of claim 13, wherein the transcript is disposed of according to the same disposition schedule as the primary record.

25. A system for authenticating a declared and/or approved record in a records management system, the system comprising:
a processor;
memory coupled to the processor, the processor being configured to:
receive declaration or approval of an object as a record;
collect available information related to the declaration or approval, including information from the computer of the user that declares or approves the record;
create a transcript of the information related to the declaration or approval;
save the transcript in the memory; and
link the transcript to the record.

26. The system of current claim 25, wherein the processor is further configured to declare the saved transcript as a record according to the same file plan as the primary record.

27. The system of claim 25, wherein information related to the declaration or approval includes the user or program declaring or approving the record.

28. The system of claim 25, wherein information related to the declaration or approval includes the internet protocol address from which the user declares or approves the record, or the media access control address that identifies the node from which the user declares or approves the record.

29. The system of claim 25, wherein information related to the declaration or approval includes a name or other description of a system used to declare or approve the record.

30. The system of claim 25, wherein information related to the declaration or approval includes at least one log or audit entry that was generated during the declaration or approval.

31. The system of claim 30, wherein the processor is further configured to archive the at least one log; and
declare the at least one log as a record.

32. The system of claim 25, wherein information related to the declaration or approval includes a globally unique identification number for the record.

33. The system of claim 25, wherein information related to the declaration or approval includes a hash of the record.

34. The system of claim 33, wherein the processor is further configured to:
revalidate the hash of the content; and
compare the revalidated hash to a stored hash value.

35. The system of claim 25, wherein the processor is further configured to:
transform the transcript into a human-readable format.

36. The system of claim 25, wherein the processor is further configured to:
dispose of the transcript according to the same disposition schedule as the primary record.
